(19) United States
(12) Patent Application Publication
(10) Pub. No.: US 2017/0039957 A1
(43) Pub. Date: Feb. 9, 2017

(54) LED DRIVER AND DISPLAY DEVICE FOR USING THE SAME

(71) Applicant: SOLUM CO., LTD., Suwon-si (KR)

(72) Inventors: Hee Seung KIM, Seoul (KR); Jae Sun WON, Suwon-Si (KR); Seung Wan YU, Suwon-Si (KR); Hyeong Kyu JEONG, Suwon-Si (KR)

(73) Assignee: SOLUM CO., LTD., Suwon-si (KR)

(21) Appl. No.: 14/816,383

(22) Filed: Aug. 3, 2015

(51) Int. Cl. G09G 3/34

(52) U.S. Cl. CPC G09G 3/3406; G09G 2310/0237; G09G 2320/02; G09G 2320/0626; G09G 2330/028

(57) ABSTRACT

The object of the present invention is to provide an LED driver capable of improving the stability by supplying the uniform current and widening the application range and a display device using the same.

The present invention provides an LED driver, which includes a power supply unit for supplying a driving current to a channel including a plurality of LEDs connected to each other in series or in parallel and a capacitor provided with a first electrode which is connected to an output terminal of the power supply unit and the channel and a second electrode which is connected to a ground, and a display device using the same.

### CROSS-REFERENCE TO RELATED APPLICATIONS

Claim and incorporate by reference domestic priority application and foreign priority application as follows:

### “CROSS REFERENCE TO RELATED APPLICATION

This application claims the foreign priority benefit under 35 U.S.C. Section 119 of Korean Patent Application Serial No. 10-2014-0110685, entitled filed Aug. 25, 2014, which is hereby incorporated by reference in its entirety into this application.”

### BACKGROUND OF THE INVENTION

1. Field of the Invention

Embodiments of the present invention relates to an LED driver and a display device for using the same.

2. Description of the Related Art

In general, the electronic device such as a mobile phone, an FPD (Flat Panel Display) frequently generates the EMI (Electro Magnetic Interference) noise problems according to the trends of miniaturization and high speed. And also, as the price competition is severe, due to the high frequency of the switching frequency and the simplification of the EMI filter the problems become critical further. Particularly, in case of FPD, due to the serial connection of the PFC (Power Factor Correnction), the DC/DC converter and the LED driver, the EMI noises are generated at various frequency bandwidths.

And also, in case of using the LED as the backlight of FPD, the backlight can be provided with a plurality of channels constituted of a plurality of LEDs for discharging the uniform light source. And, larger the size of FPD, longer the lengths of each channel, it plays a role of antenna capable of discharging the EMI noises, thereby making the problems of the EMI noises to be further critical. And also, although the back chassis is employed in order to attenuate the EMI noises, the use of the back chassis is minimized or is not employed for saving the cost according to deepening the price competition, whereby the EMI emission and conduction become the severe problems in the FPD.

### SUMMARY OF THE INVENTION

The present invention has been invented in order to overcome the above-described problems and it is, therefore, an object of the present invention to provide an LED driver capable of attenuating an electromagnetic wave noise and being inexpensive and a display device using the same.

In accordance with a first embodiment of the present invention to achieve the object, there is provided an LED driver including: a power supply unit for supplying a driving current to a channel including a plurality of LEDs connected to each other in series or in parallel; and a capacitor provided with a first electrode which is connected to an output terminal of the power supply unit and the channel and a second electrode which is connected to a ground.

In accordance with a second embodiment of the present invention to achieve the object, there is provided a display device, including: a display unit; an LED driver for supplying power to the display unit; and a tuner unit for determining a frequency bandwidth of an image signal through an output terminal, wherein the LED driver includes: a power supply unit for receiving an input power through an input terminal and for supplying a driving power to the display unit; a channel for receiving the driving power through a wiring connected to the output terminal; and a first capacitor provided with a first electrode connected to the wiring and a second electrode connected to a ground of the tuner unit.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a circuit diagram showing a first embodiment of an LED driver in accordance with the present invention;

FIG. 2 is a circuit diagram showing a second embodiment of an LED driver in accordance with the present invention;

FIG. 3A is a graph comparing a waveform of the current applying to a channel in case when a first capacitor is not connected with a waveform of the current applying to the channel in case when the first capacitor is connected;

FIG. 3B is a graph comparing a waveform showing a voltage of a first node between an inductor and a channel in case when a first capacitor is not connected with a waveform showing a voltage of a first node between the inductor and the channel in case when the first capacitor is connected;

FIG. 4A is an exploded diagram showing a first embodiment of an FPD employing the LED driver shown in FIG. 1;

FIG. 4B is an exploded diagram showing a second embodiment of an FPD employing the LED driver shown in FIG. 1;

FIG. 5 is a diagram showing a connection relation between a power board and a tuner unit of the FPD shown in FIG. 4B;

FIG. 6A is a graph showing an EMI emission waveform of the FPD which does not employ a back chassis; and

FIG. 6B is a graph showing an EMI emission waveform of the FPD shown in FIG. 4B which does not employ a back chassis.

### DETAILED DESCRIPTION OF THE PREFERABLE EMBODIMENTS

A matter regarding to an operational effect including a technical configuration for an object of an LED driver and a display device for using the same in accordance with the present invention will be clearly appreciated through the following detailed description with reference to the accompanying drawings showing preferable embodiments of the present invention.

Further, in describing the present invention, descriptions of well-known techniques are omitted so as not to unnecessarily obscure the embodiments of the present invention. In the present specification, the terms “first,” “second,” and the like are used for distinguishing one element from another, and the elements are not limited by the above terms.

In the following detailed description of the present invention, reference is made to the accompanying drawings that show, by way of illustration, specific embodiments in which the present invention may be practiced. These embodiments are described in sufficient detail to enable those skilled in the art to practice the embodiments. It is to be understood that the various embodiments, although different, are not necessarily mutually exclusive. For example, a particular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments. The following detailed description is, therefore, not to be taken in a limiting sense, and the scope of the embodiments is defined only by the appended claims, appropriately interpreted, along with the full range of equivalents to which the claims are entitled. In the drawings, like numerals refer to the same or similar functionality throughout the several views.

Hereinafter, embodiments of the present invention will be described in detail with reference to the accompanying drawings so that those skilled in the art can easily practice the present invention.

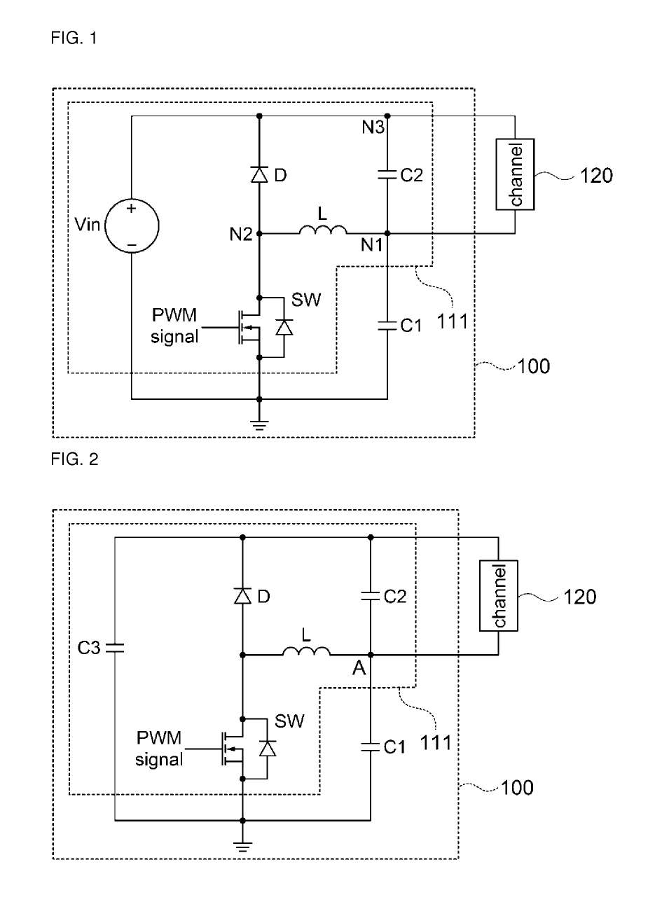

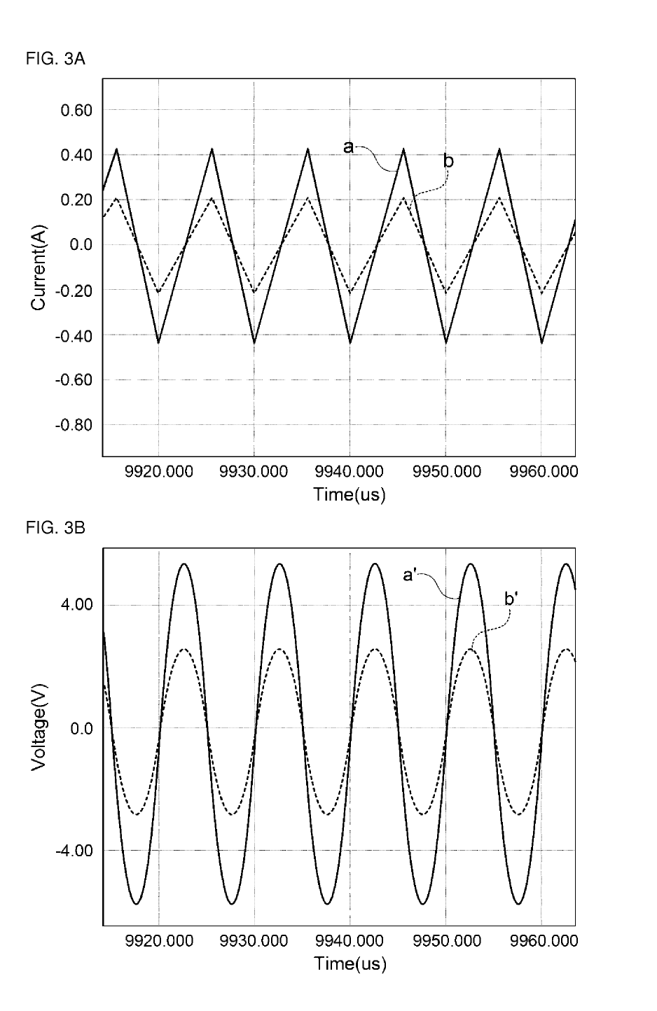

FIG. 1 is a circuit diagram showing a first embodiment of an LED driver in accordance with the present invention and FIG. 2 is a circuit diagram showing a second embodiment of an LED driver in accordance with the present invention.

Referring to FIG. 1, an LED driver 110 can include a power supply unit 111 for supplying a driving current to a channel 120 including at least one LED bar on which a plurality of LEDs (Light Emitting Diode) are connected in series and a first capacitor C1 provided with a first electrode connected to an output terminal of the power supply unit 111 and a channel 120a and a second electrode connected to a ground.

The power supply unit 111 can include an inductor L provided with one end connected to a first node N1 and the other end connected to a second node N2, a switch SW for controlling the direction of current flowing into the inductor L corresponding to the turn on/off operations by connecting one end to the second node N2 and the other end to the ground, a first capacitor C1 provided with a first electrode connected to the first node N1 and a second electrode connected to the ground, a diode provided with an anode electrode connected to the second node N2 and a cathode electrode connected a third node N3 and a second capacitor C2 provided with a first electrode connected to the third node N3 and a second electrode connected to the first node N1.

And also, the power supply unit 111 can supply the driving current to the channel 120 by receiving the input power Vin. Although the input power Vin may be a direct current, but it is not limited thereto. The power supply unit 111 can include the inductor L for supplying the driving current with a predetermined size and the switch SW for controlling the size of the driving current flowing into the inductor L. The switch SW can control the amount of driving current flowing into the inductor L by controlling the ratio of turn on/off according to a PWM signal. The switch SW may be a device capable of switching the flow of current such as a MOS transistor, a FET, a BJT or the like. And also, the PWM signal can control the ratio of turn on/off by sensing the amount of the driving current flowing into the channel 120. And, the switch SW is capable of controlling the amount of the driving current flowing into the inductor L by changing the turn on/off frequency of the switch SW by receiving the frequency control signal except the PWM signal. And, the power supply unit 111 includes the diode D and the diode D allows the current flowing into the inductor L to be free-wheeling during the turn off. Herein, although the power supply unit 111 is described as a low side Buck converter, it is exemplified as only one example without limiting thereto, and it may be an LLC, a boost converter or the like.

The channel 120 for receiving the current from the power supply unit 111 may be a plurality of LEDs to be connected to each other in series or in parallel. And also, the channel 120 may be in the shape of a bar. In case of when the channel 120 is not connected to the ground, it can play a role of antenna capable of emitting noises. The longer the length of the channel, the easier the radiation of noises. Herein, the channel 120 is not limited to that it includes a plurality of LEDs, it is allowable if it consumes the energy by the flow of current.

The first capacitor C1 may be a path to connect the channel 120 with the ground by being connected between the channel 120 and the ground. And, since the alternate component applied to the channel 120 may be transferred to the ground by the first capacitor C1, the alternate component applied to the channel 120 can be minimized. And, the power supply 111 can further include the second capacitor C2 at the output terminal. And also, the size of capacitance of the first capacitor C1 may be equal to that of the second capacitor C1. Also, the size of capacitance of the first capacitor C1 may be smaller than that of the second capacitor C2. If the size of the second capacitor C2 is small, since a noise path due to the second capacitor C2 may be formed at the high frequency bandwidth, the noise may be transferred to the noise easily. The same size of capacitance does not mean to exactly match; and it can include a slight difference. Since the first capacitor C1 and the second capacitor C2 are connected to the channel 120a in parallel, the amount of current supplied to the channel 120 may be reduced.

And also, the power supply unit 111 may receive a predetermined voltage through the direct power source. At this time, although the power supply unit 111 receives the predetermined voltage from the direct power source as shown in FIG. 1, it can also receive the direct power by the third capacitor C3 as shown in FIG. 2.

FIG. 3a is a graph comparing a waveform of the current applying to a channel in case when a first capacitor is not connected with a waveform of the current applying to the channel in case when the first capacitor is connected, and FIG. 3b is a graph comparing a waveform showing a voltage of a first node between an inductor and a channel in case when a first capacitor is not connected with a waveform showing a voltage of a first node between the inductor and the channel in case when the first capacitor is connected. At this time, the size of the inductor L of the LED driver 110 is 400 μH, the channel 120 connected to the LED driver 110 transmits the input voltage having 135V at the state that the resistor is 160Ω, and it makes the switching frequency of the switch SW to be 100 kHz. And also, a represents the size of the current flowing into the second capacitor C2 at the LED driver 110 under the condition that the first capacitor C1 is not connected; and, b represent the size of the current flowing into the second capacitor C2 at the LED driver 110 under the condition that the first capacitor C1 is connected. Also, a′ represents the size of the alternate component among the voltage outputted from the LED driver 110 under the condition that the first capacitor C1 is not connected; and, b′ represents the size of the alternate component among the voltage outputted from the LED driver 110 under the condition that the first capacitor C1 is connected.

And also, the current of 480 mA is flown into the channel 120 of the LED driver 110 and the output voltage of the power supply unit is 85V. At this time, although the ripple (the difference between the maximum value and the minimum value) of the current is the size of 0.86 A before connecting the first capacitor C1, as shown in FIG. 3A; but, after connecting the first capacitor C1, the ripple of the current is 0.42 A and its change width becomes reduced. And also, as shown FIG. 3B, before connecting the first capacitor C1, the voltage ripple (the difference between the maximum value and the minimum value) is 11.09V; but, after connecting the first capacitor C1, the change width of the voltage also reduces to 5.37V.

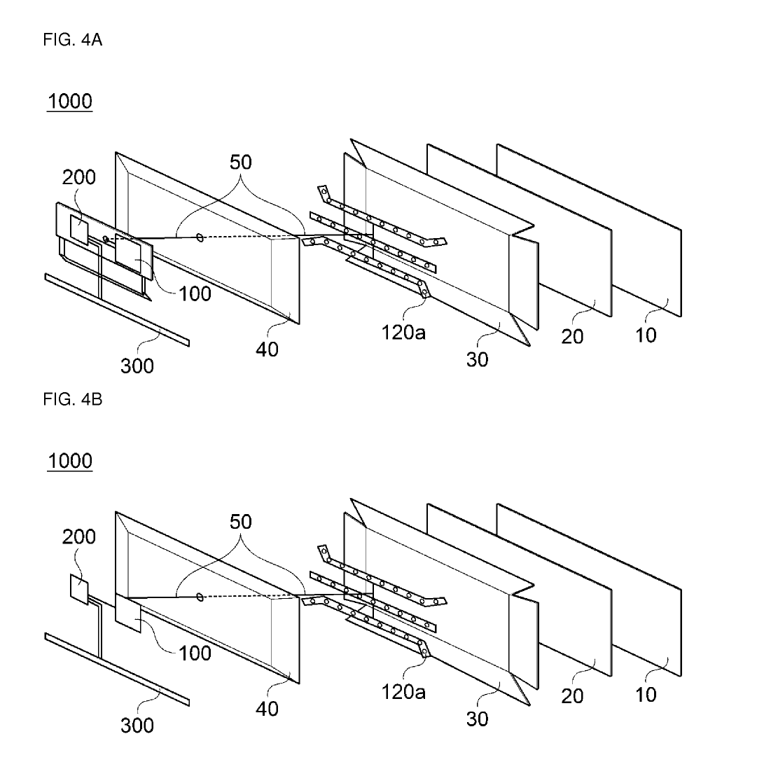

FIG. 4a is an exploded diagram showing a first embodiment of an FPD employing the LED driver shown in FIG. 1 and FIG. 4b is an exploded diagram showing a second embodiment of an FPD employing the LED driver shown in FIG. 1.

Referring to FIG. 4A and FIG. 4B, the FPD 1000 can include a panel 10, an optical sheet 20, a waveguide plate 30, a plurality of channels 120a, a cover frame 40, a power board 100 for generating and supplying the power, an image board 200 and a function board 300 for transmitting a control signal to control the power board 100 and the image board 200. The FPD 1000, as shown in FIG. 3A, can further include a back chassis 60 having the size capable of covering the power board 100 and the image board 200. Herein, the panel 10, the optical sheet 20, the waveguide plate 30 and the plurality of channels 120a can be named as a display unit to display the image at the FPD 1000. The panel 10 can display the image by receiving the driving signal and the image signal from the image board 200. The optical sheet 20 and the waveguide plate 30 can transmit the light emitted from each LED of the channels to the panel 10. Each channel 120a has the shape of a bar with a predetermined length and the plurality of LEDs 120a may be arranged at the channels 120a. The length of the channel 120a may be determined corresponding to the size of the FPD 1000. The power board 100 can supply the power to the image board 200 and each channel 120a through the wiring 50 by receiving the input power Vin. The power board 100 can include the LED driver 110, as shown in FIG. 1, in order to generate the power. The image board 200 is operated by receiving the power through the power board 100 and can transmit the image signal and the driving signal to the panel 10. The function board 300 can output the control signal to control the power board 100 and the image board 200.

As shown in FIG. 4A, in case when the size of the back chassis 60 is very small, since in the FPD 1000 the channels 120 are connected to the ground through the first capacitor C1 as shown in FIG. 1, although the size of the back chassis 60 is small, the alternate signal applied to the channels 120 may be smoothly transmitted to the ground. Herein, the size of the back chassis 60 may be the size to cover the power board 100 and the image board 200. And, as shown in FIG. 3B, even when the FPD 1000 does not employ the back chassis 60, the alternate signal applied to the channels 120 through the ground, where the channels 120 are connected to the other components of the FPD 1000 through the first capacitor C1, as shown in FIG. 1, may be smoothly transmitted to the ground. Herein, the other components of the FPD 1000 may be the tuner unit for determining the frequency bandwidth of the image signal to be displayed at the display unit of the FPD 1000. And also, it may be the ground of the image board 200 and the function board 300.

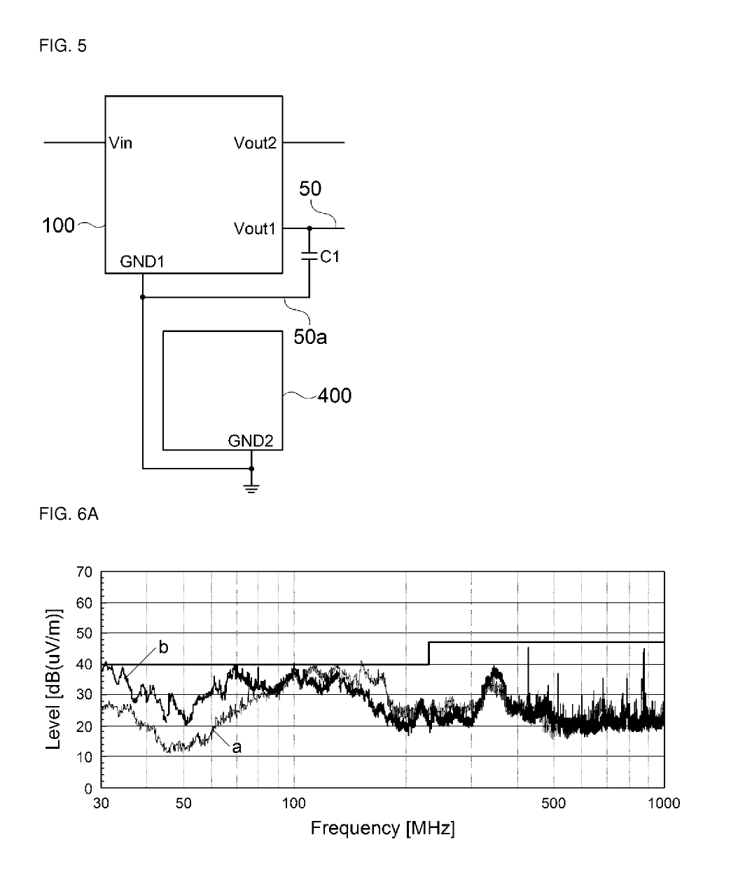

FIG. 5 is a diagram showing a connection relation between a power board and a tuner unit of the FPD shown in FIG. 4b.

Referring to FIG. 5, the power board 100 includes the LED driver 110 and the first capacitor C1, wherein the LED driver 110 can include a first output terminal Vout1 and a second output terminal Vout2 for supplying the power to the plurality of channels 120a by receiving the input power Vin. The first output terminal Vout1 and the second output terminal Vout2 can supply the power to each of the channel 120a and the image board 200 through the first wiring 50, respectively. The power supplied to the first output terminal Vout1 and the second output terminal Vout2 may be the powers different from each other and different from each other in their sizes. And also, although the LED driver 110 is described as supplying the power to the first output terminal Vout1 and the second output terminal Vout2, it is not limited thereto, but further power can be generated to output. And, the first capacitor C1 is connected to the first wiring 50 that the first electrode supplies the power to the channels 120a from the first output terminal Vout1 and the second output terminal Vout2 by the second wiring 50a and the second electrode may be connected to the ground of the tuner unit 400. However, it is not limited thereto; and, it is allowable to be connected with the ground of the image board and the function board.

The tuner unit 400 may be connected to the ground with the second electrode of the first capacitor C1. Accordingly, the EMI noise components of the channels 120a transmitted through the first capacitor C1 can be transmitted to the ground of the tuner unit 400 by the first capacitor C1.

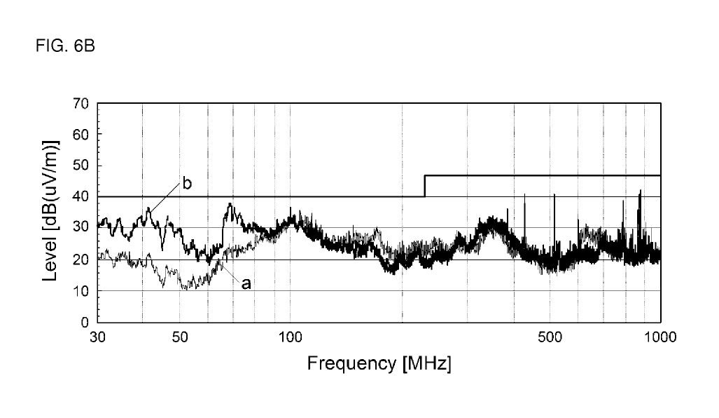

FIG. 6a is a graph showing an EMI emission waveform of the FPD which does not employ a back chassis and FIG. 6b is a graph showing an EMI emission waveform of the FPD shown in FIG. 4b which does not employ a back chassis. And, a represents the EMI noises emitted to a horizontal direction and b represents the EMI noises emitted to the vertical direction.

Referring to FIG. 6A and 6B, the experiment is performed by using the FPD that the size of the display unit is 48 inches, the FPD 1000 must satisfy that the noise level is below 40 dB at the frequency below 250 MHz and satisfy that the noise level is below if exceeding 250 MHz. However, as shown in FIG. 5A, in case of the FPD 1000 without employing the back chassis simply, it occasionally satisfies the condition of the 40 dB at the horizontal direction (a) and the vertical direction (b) under the condition that the level of the EMI emission is below 250 MHz. Whereas, in case when the first capacitor C1 is connected to the output terminal, although the FPD 1000 does not employ the back chassis, the condition that the EMI emission level is 40 dB in the horizontal direction (a) and the vertical direction (b) at the frequency below 250 MHz is satisfied. And, even when the EMI emission level is above 250 MHz, at both of the horizontal direction (a) and the vertical direction (b), the EMI emission level is lower than in case when the first capacitor C1 is not employed.

In accordance with the LED driver of the present invention and the display device using the same, the problems of EMI emission and conduction can be solved by attenuating the effect of noises through the simple structure. And also, the manufacturing cost can be saved.

In the scope of claims of the present specification, the elements represented as the means for performing a specific function include an arbitrary method to perform the specific function, such elements can include an arbitrary type software including the combination of circuit elements to perform the specific function, or a firmware, a microcode combined with an appropriate circuit for performing the software to perform the specific function.

Reference in the specification to “an embodiment” of the present principles, as well as other variations thereof, means that a particular feature, structure, characteristic, and so forth described in connection with the embodiment is included in at least one embodiment of the present principles. Thus, the appearances of the phrase “in an embodiment”, as well as any other variations, appearing in various places throughout the specification are not necessarily all referring to the same embodiment.

Reference in the specification to “connect” or “connecting”, as well as other variations thereof, means that an element is directly connected to the other element or indirectly connected to the other element through another element. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

What is claimed is:

1. An LED driver comprising:
a power supply unit for supplying a driving current to a channel including a plurality of LEDs connected to each other in series or in parallel; and
a capacitor provided with a first electrode which is connected to an output terminal of the power supply unit and the channel and a second electrode which is connected to a ground.

2. The LED driver according to claim 1, wherein a second capacitor is connected to the output terminal and the second capacitor is connected the first capacitor in series between the output terminal and the ground.

3. The LED driver according to claim 2, wherein a size of capacitance of the first capacitor is equal to or smaller than that of the second capacitor.

4. The LED driver according to claim 1, wherein the power supply unit includes a switch and the switch controls an amount of the driving current by performing a switching operation corresponding to the amount of the driving current.

5. The LED driver according to claim 1, wherein the power supply unit is a Buck converter.

6. The LED driver according to claim 1, wherein the power supply unit includes:
an inductor provided with one end connected to a first node and the other end connected to a second node;
a switch for controlling a direction of current flowing into the inductor corresponding to turn on/off operations by connecting one end thereof to the second node and the other end to the ground;
a first capacitor provided with a first electrode connected to the first node and a second electrode connected to the ground;
a diode provided with an anode electrode connected to the second node and a cathode connected to a third node; and
a second capacitor provided with a first electrode connected to the third node and a second electrode connected to the first node.

7. A display device, comprising:
a display unit;
an LED driver for supplying power to the display unit; and
a tuner unit for determining a frequency bandwidth of an image signal displayed in the display unit,
wherein the LED driver includes:
a power supply unit for receiving an input power through an input terminal and for supplying a driving power to the display unit through an output terminal;
a channel for receiving the driving power through a wiring connected to the output terminal; and
a first capacitor provided with a first electrode connected to the wiring and a second electrode connected to a ground of the tuner unit.

8. The display device according to claim 7, wherein the second capacitor is connected to the output terminal and the second capacitor is connected to the first capacitor in series between the output terminal and the ground.

9. The display device according to claim 8, wherein a size of capacitance of the first capacitor is equal to or smaller than that of the second capacitor.

10. The display device according to claim 7, wherein the power supply unit is a Buck converter.

11. The power display device according to claim 7, wherein the power supply unit includes:
an inductor provided with one end connected to a first node and the other end connected to a second node;
a switch for controlling a direction of current flowing into the inductor corresponding to turn on/off operations by connecting one end thereof to the second node and the other end to the ground;
a first capacitor provided with a first electrode connected to the first node and a second electrode connected to the ground;
a diode provided with an anode electrode connected to the second node and a cathode connected to a third node; and
a second capacitor provided with a first electrode connected to the third node and a second electrode connected to the first node.
